(19) United States
(12) Patent Application Publication
(10) Pub. No.: US 2014/0041682 A1
(43) Pub. Date: Feb. 13, 2014

(54) METHOD FOR CLEANING MICROWAVE PROCESSING APPARATUS

(71) Applicant: TOKYO ELECTRON LIMITED, Minato-ku (JP)

(72) Inventors: Taichi MONDEN, Yamanashi (JP); Yoshiro KABE, Yamanashi (JP); Kouji SHIMOMURA, Yamanashi (JP)

(73) Assignee: TOKYO ELECTRON LIMITED, Minato-ku (JP)

(21) Appl. No.: 13/960,037

(22) Filed: Aug. 6, 2013

(30) Foreign Application Priority Data
Aug. 9, 2012 (JP) 2012-177083

(51) Int. Cl. B08B 7/00

(52) U.S. Cl. CPC B08B 7/0035
USPC 134/1

(57) ABSTRACT

A method for cleaning a microwave processing apparatus including a processing chamber for accommodating therein an object to be processed, a microwave introducing unit for introducing microwaves into the chamber, and a gas introducing unit for introducing a gas into the processing chamber is provided. The method includes loading an object for cleaning into the processing chamber, introducing a gas into the processing chamber, introducing microwaves into the processing chamber, and unloading the object from the processing chamber.

### CROSS-REFERENCE TO RELATED APPLICATION

This application claims priority to Japanese Patent Application No. 2012-177083 filed on Aug. 9, 2012, the entire contents of which are incorporated herein by reference.

### FIELD OF THE INVENTION

The present invention relates to a method for cleaning a microwave processing apparatus; and more particuarly, to a method for cleaning a processing chamber of the microwave processing apparatus.

### BACKGROUND OF THE INVENTION

In a semiconductor wafer (hereinafter, simply referred to as “wafer”) as an object to be processed, crystallization of amorphous silicon or activation of doped impurities is generally realized by heat treatment using a lamp heater. With such heat treatment, the amorphous silicon is fused and crystallized, and a portion where the impurities are doped is heated so that the impurities are activated.

In the heat treatment using a lamp heater, the wafer surface is heated and the heat is transmitted to a portion that needs to be heated. This may cause a shape of a trench or a hole in the surface of the wafer to collapse. Recently, heat treatment using a microwave is being studied (see, e.g., Japanese Patent Application No. 2012-040095). In the heat treatment using a microwave, for example, when dipoles of impurities exist in a wafer to which microwaves are irradiated, the dipoles are vibrated by the microwaves, thereby generating frictional heat. The vicinity of the dipoles is heated by the frictional heat (dielectric heating).

In other words, by positioning dipoles at a portion inside the wafer which needs to be heated, only the corresponding portion inside the wafer can be selectively heated without having to heat the surface of the wafer. In the treatment using a microwave, unnecessary portions are not heated by performing selective heating, so that energy efficiency can be increased and power consumption can be decreased.

In the heat treatment using a microwave, in order to omnidirectionally irradiate microwaves to the wafer, the microwaves are introduced into a chamber (processing container) accommodating therein a wafer and then reflected from the inner surfaces of the chamber so as to be scattered in the chamber. The scattered microwaves easily cause abnormal discharge. Therefore, the chamber is maintained substantially at the atmospheric pressure in order to suppress an occurrence of abnormal discharge.

If the treatment using a microwave is repetitively performed in the microwave processing apparatus, the chamber needs maintenance and is exposed to the atmosphere during the maintenance. Consequently, when the chamber is exposed to the atmosphere, particles, metal atoms or the like may enter the chamber from the outside.

In the case of a plasma processing apparatus for performing plasma treatment on a wafer, a vacuum pump such as a turbo molecular pump is provided to depressurize the inside of the chamber. Air, including particles or the like, in the chamber is discharged to the outside of the chamber by using the turbo molecular pump.

Since, however, the treatment using a microwave is carried out substantially under the atmospheric pressure, unlike the plasma treatment, the microwave processing apparatus does not have a vacuum pump such as a turbo molecular pump or the like. Accordingly, particles and the like entering the chamber during the maintenance cannot be forcedly discharged, and such particles and the like may contaminate the chamber.

### SUMMARY OF THE INVENTION

In view of the above, the present invention provides a method for cleaning a microwave processing apparatus, which is capable of preventing the inside of the chamber from being contaminated by the particles and the like.

In accordance with an aspect of the present invention, there is probided a method for cleaning a microwave processing apparatus including a processing chamber for accommodating therein an object to be processed, a microwave introducing unit for introducing microwaves into the chamber, and a gas introducing unit for introducing a gas into the processing chamber, the method including: loading an object for cleaning into the processing chamber; introducing a gas into the processing chamber; introducing microwaves into the processing chamber; and unloading the object from the processing chamber.

### BRIEF DESCRIPTION OF THE DRAWINGS

The above and other objects and features of the present invention will become apparent from the following description of embodiments, given in conjunction with the accompanying drawings, in which:

FIG. 1 is a cross sectional view schematically showing a configuration of a microwave processing apparatus to which a method for cleaning a microwave processing apparatus in accordance with an embodiment of the present invention is applied;

FIG. 2 is a flowchart of a chamber cleaning process as the method for cleaning a microwave processing apparatus in accordance with the embodiment of the present invention;

FIG. 3 is a cross sectional view showing a gas flow formed by introducing N₂ gas into a chamber shown in FIG. 1;

FIG. 4 is a cross sectional view showing scattering of microwaves in the case of introducing the microwaves into the chamber shown in FIG. 1;

FIG. 5 is a cross sectional view for explaining the case of using a small dummy wafer in the chamber cleaning process of FIG. 2;

FIG. 6 is a flowchart of a first modification of the chamber cleaning process of FIG. 2;

FIG. 7 is a flowchart of a second modification of the chamber cleaning process of FIG. 2;

FIG. 8 is a graph showing changes in density of metal atoms discharged from the chamber in the case of performing the chamber cleaning process of FIG. 2; and

FIG. 9 is a graph showing changes in the number of particles discharged from the chamber in the case of performing the chamber cleaning process of FIG. 2.

### DETAILED DESCRIPTION OF THE EMBODIMENTS

Hereinafter, embodiments of the present invention will be described with reference to the accompanying drawings which form a part hereof.

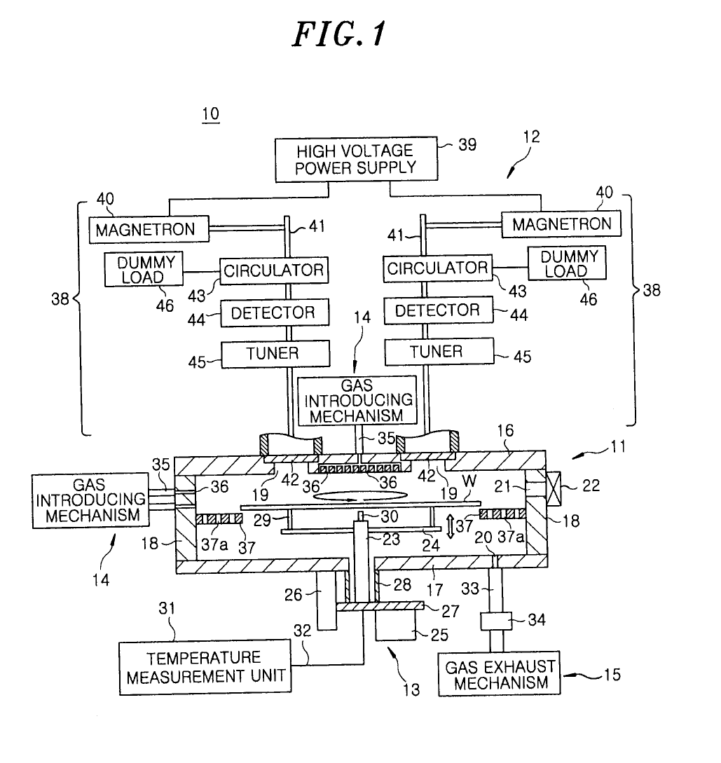

Referring to FIG. 1, a microwave processing apparatus 10 includes: a chamber (processing chamber) 11 accommodating therein a wafer W (object to be processed); a microwave introducing mechanism 12 (microwave introducing unit) for introducing microwaves into the chamber 11; a supporting mechanism 13 for supporting a wafer W in the chamber 11; a gas introducing mechanism 14 (gas introducing unit) for introducing a predetermined gas into the chamber 11; and a gas exhaust mechanism 15 for evacuating the chamber 11.

The chamber 11, which has, e.g., a rectangular parallelepiped shape, includes a plate-shaped ceiling portion 16, a bottom portion 17 opposite to the ceiling portion 16, and sidewalls 18 for connecting the ceiling portion 16 and the bottom portion 17. The ceiling portion 16, the bottom portion 17, and the sidewalls 18 are made of metal, e.g., aluminum or stainless steel. The ceiling portion 16 has a plurality of microwave inlet ports 19 penetrating therethrough in a vertical direction as shown in the drawing (hereinafter, simply referred to as “vertical direction”). The bottom portion 17 has a gas exhaust port 20. The inner surface of each of the sidewalls 18 is flat and reflects the microwaves introduced into the chamber 11. Further, a loading/unloading port 21 of the wafer W is provided at one of the sidewalls 18. A gate valve 22 is provided at the loading/unloading port 21 and moves in a vertical direction to open and close the loading/unloading port 21.

The supporting mechanism 13 has a shaft 23 extending through the bottom portion 17 along the vertical direction; a plurality of arms 24 extending in a horizontal direction, as shown in FIG. 1, from an upper portion of the shaft 23; a rotation driving unit 25 for rotating the shaft 23; an elevation driving unit 26 for vertically moving the shaft 23; and a shaft base portion 27, to which the rotation driving unit 25 and the elevation driving unit 26 are attached, serving as a base of the shaft 23. The shaft 23 is isolated from the outside of the chamber 11 by a bellows 28 covering the shaft 23.

In the supporting mechanism 13, the wafer W is supported by pins 29 protruding from the leading ends of the arms 24. In the chamber 11, the wafer W mounted on the arms 24 is rotated in a horizontal plane (indicated by a black arrow in FIG. 1) by the rotation of the shaft 23 and moved in a vertical direction by the elevating movement of the shaft 23 (indicated by a white arrow). Further, a radiation thermometer 30 for measuring a temperature of the wafer W is provided at the leading end of the shaft 23 and is connected through wiring 32 to a temperature measurement unit 31 provided outside the chamber 11.

The gas introducing mechanisms 14 provided at the ceiling portion 16 and the sidewall 18 are connected to a plurality of gas inlet ports 36 that are opened at the ceiling portion 16 and the sidewall 18 via a plurality of lines 35. Accordingly, a processing gas, a cooling gas, or a purge gas, e.g., N₂ gas, Ar gas, He gas, Ne gas, O₂ gas, or H₂ gas, is introduced into the chamber 11 in a downflow manner and a sideflow manner.

Each of the lines 35 is provided with a mass flow controller (not shown) and an opening/closing valve (not shown), which control a type and a flow rate of the processing gas, the cooling gas, or the purge gas. In FIG. 1, the gas inlet port 36 is opened at the ceiling portion 16 and the sidewall 18. However, a stage for mounting thereon a wafer W may be provided at the supporting mechanism 13 and a plurality of gas inlet ports may be opened at the mounting surface of the stage so that the purge gas and the like may be introduced into the chamber 11 in an upflow manner.

The gas exhaust mechanism 15 is connected to a gas exhaust port 20 through a gas exhaust line 33. A pressure control valve 34 is provided in the gas exhaust line 33 to control a pressure in the chamber 11. Moreover, it is not necessary to provide the gas exhaust mechanism 15 in the microwave processing apparatus 10. When the gas exhaust mechanism 15 is not provided, the gas exhaust port 20 is directly connected to a gas exhaust line of a gas exhaust equipment in a factory where the microwave processing apparatus 10 is installed.

In the processing chamber 11, a rectifying plate 37 is provided between the arms 24 and the sidewalls 18. The rectifying plate 37 has a plurality of through holes 37a. The flow of atmosphere near the wafer W is regulated by allowing atmosphere in the chamber 11 to flow through the through holes 37a.

The microwave introducing mechanism 12 is disposed above the ceiling portion 16 and includes a plurality of microwave units 38 for introducing a microwave into the chamber 11 and a high voltage power supply 39 connected to the microwave units 38.

Each of the microwave units 38 has a magnetron 40 for generating a microwave, a waveguide 41 for transmitting the generated microwave to the chamber 11, and a transmission window 42 fixed to the ceiling portion 16 so as to cover the microwave inlet ports 19.

The magnetrons 40 are connected to the high voltage power supply 39. Using a high voltage current supplied from the high voltage power supply 39, the magnetrons generate microwaves of various frequencies, e.g., 2.45 GHz or 5.8 GHz. Each of the magnetron 40 selectively generates a microwave having a frequency suitable for heat treatment performed by the microwave processing apparatus 10.

The waveguide 41 has a rectangular cross section and a square column shape. The waveguide 41 is installed upward from the microwave inlet port 19 to connect the magnetron 40 and the transmission window 42. The magnetron 40 is provided near the upper end of the waveguide 41. The microwave generated by the magnetron 40 is transmitted in the waveguide 41 and introduced into the chamber 11 through the transmission window 42.

The transmission window 42 is made of a dielectric material, e.g., quartz or ceramic. The gap between the transmission window 42 and the ceiling portion 16 is airtightly sealed by a sealing member. The distance from the transmission window 42 to the wafer W supported by the arms 24 is preferably, e.g., about 25 mm or more.

Each of the microwave units 38 further has a circulator 43, a detector 44, and a tuner 45, and a dummy load 46 connected to the circulator 43. The circulator 43, the detector 44, and the tuner 45 are sequentially arranged on the waveguide 41 in that order from the top. The circulator 43 and the dummy load 46 serve as isolators of the microwaves reflected from the inside of the chamber 11. The dummy load 46 converts the reflected wave separated from the waveguide 41 by the circulator 43 into heat to be consumed.

The detector 44 detects the reflected wave from the inside of the chamber 11, and the tuner 45 matches an impedence between the magnetron 40 and the chamber 11. The tuner 45 has a conductor plate (not shown) that can protrude into the waveguide 41 and adjusts the impedence by controlling the protrusion amount of the conductor plate such that the power of the reflected wave is minimized.

In the microwave processing apparatus 10, the microwaves introduced into the chamber 11 are reflected by the inner surfaces of the sidewalls 18 and the like and scattered. The scattered microwaves are omnidirectionally irradiated to the wafer W. The microwaves irradiated to the wafer W vibrate dipoles in the wafer W, thereby generating frictional heat. The wafer W is heated mainly by the frictional heat. In other words, the treatment using a microwave is carried out. At this time, the shaft 23 is rotated to rotate the wafer W in a horizontal plane, so that the scattered microwaves can be uniformly irradiated to each portion of the wafer W.

Further, in the microwave processing apparatus 10, when the chamber 11 is depressurized while the microwaves are being scattered, abnormal discharge may occur. Therefore, when the microwaves are irradiated onto the wafer W, the inside of the processing chamber 31 is maintained substantially at the atmospheric pressure by the pressure control valve 34 of the gas exhaust mechanism 15.

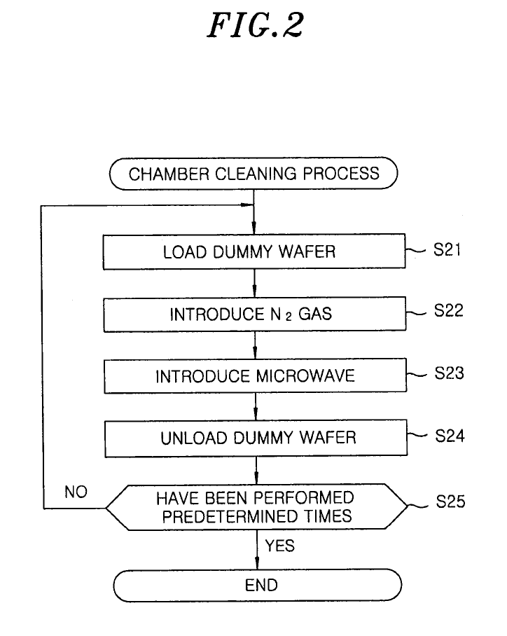

A method for cleaning a microwave processing apparatus according to the present embodiment will be described with reference to a flowchart of a chamber cleaning process shown in FIG. 2. The chamber cleaning process is performed after the chamber 11 that has been exposed to the atmosphere during maintenance is closed and before the treatment using microwaves, e.g., heat treatment, is performed on a wafer W for manufacturing semiconductor devices. Further, the chamber cleaning process may be performed during a process consecutively performed on the wafer W, e.g., heat treatment, as well as after the chamber 11 is exposed to the atmosphere.

Referring to FIG. 2, first, the pressure in the chamber 11 is raised to a pressure higher than that of the outside environment by the pressure control of the pressure control valve 34 of the gas exhaust mechanism 15 and the gas supply. Next, the loading/unloading port 21 is opened by the gate valve 22; and a dummy wafer Wd, different from the wafer W for manufacturing semiconductor devices, is loaded into the chamber 11 through the loading/unloading port 21 (loading step) (step S21) and supported by the supporting mechanism 13.

Thereafter, the loading/unloading port 21 is closed by the gate valve 22. Then, a predetermined gas, e.g., N₂ gas, is introduced into the chamber 11 by the gas introducing mechanism 14 and the gas in the chamber 11, which contains the introduced N₂ gas, is discharged to the outside of the chamber 11 by the gas exhaust mechanism 15, thereby, forming a gas flow, in the chamber 11, directed toward the outside of the chamber 11 (gas introducing step) (step S22).

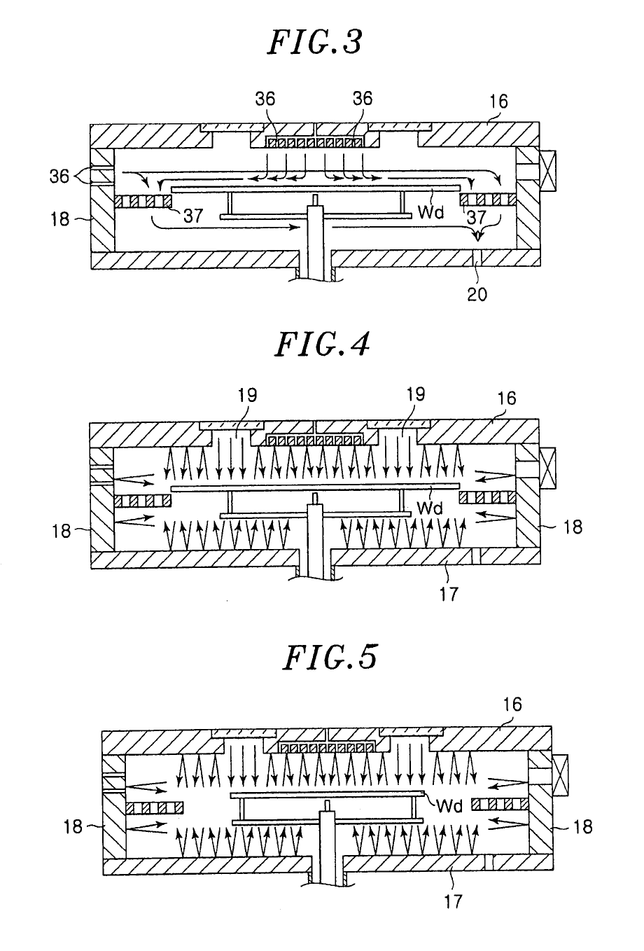

Specifically, as shown in FIG. 3, N₂ gas is injected onto the surface of the dummy wafer Wd through the gas inlet ports 36 of the gas introducing mechanism 14 provided at the ceiling portion 16. The N₂ gas injected to the surface of the dummy wafer Wd flows along the surface of the dummy wafer Wd and then flows below the dummy wafer Wd toward the gas exhaust port 20, after passing through the rectifying plate 37. Moreover, as shown in FIG. 3, N₂ gas is injected into the chamber 11 in a horizontal direction through the gas inlet ports 36 of the gas introducing mechanism 14 provided at the sidewall 18. The injected N₂ gas passes through the rectifying plate 37 and flows below the dummy wafer Wd, or flows along the surface of the dummy wafer Wd and then below the dummy wafer Wd toward the gas exhaust port 20 after passing through the rectifying plate 37. In FIG. 3, the flow of N₂ gas is indicated by arrows.

Next, the microwaves are introduced into the chamber through the microwave inlet port 19 by the microwave introducing mechanism 12 (microwave introducing step) (step S23) and reflected by the inner surfaces such as the sidewalls 18 of the chamber 11 and the like to be scattered (see FIG. 4). The scattered microwaves are omnidirectionally irradiated onto the dummy wafer Wd and also to the ceiling portion 16, the bottom portion 17, and the sidewalls 18.

The microwaves irradiated to the dummy wafer Wd vibrate dipoles in the dummy wafer Wd, thereby generating frictional heat. The dummy wafer Wd is heated by the frictional heat (dielectric heating). The heated dummy wafer Wd radiates heat toward the surfaces of the ceiling portion 16, the bottom portion 17, and the sidewalls 18. When the dummy wafer Wd is made of a conductor or a semiconductor, an eddy current is generated at the dummy wafer Wd by the microwaves. Further, the eddy current flows through the dummy wafer Wd and heat is generated (induction heating). Thus, the radiant heat from the dummy wafer Wd includes heat by dielectric heating and heat by induction heating.

Further, the ceiling portion 16, the bottom portion 17, and the sidewalls 18 (hereinafter, referred to as “sidewalls 18 and the like”) have surfaces covered with a dielectric material such as yttria, alumite, or the like. Since, however, they are made of aluminum or stainless steel, the microwaves irradiated to the sidewalls 18 and the like generate an eddy current in the sidewalls 18 and the like. When the eddy current flows in the sidewalls 18 and the like, heat is generated at the sidewalls 18 and the like (induction heating) corresponding to the internal resistance.

Particularly, the eddy current preferentially flows near the surface of the sidewalls 18 and the like due to skin effect, so that the vicinity of the surface of the sidewalls 18 and the like is positively heated by induction heating.

In other words, the vicinity of the surface of the sidewalls 18 and the like is positively heated due to the radiant heat from the dummy wafer Wd and the eddy current flowing in the sidewalls 18 and the like. As a result, the temperature increases. Thus, the particles and the metal atoms, which enter the chamber 11 to be attached to the surfaces of the sidewalls 18 and the like while the chamber is exposed to the atmosphere, are easily peeled off from the sidewalls 18 and the like by thermal stress caused by the high temperature of surface vicinity of the sidewall 18 and the like. The peeled particles and metal atoms are discharged from the chamber 11 by the gas flow directed toward the outside of the chamber 11.

Next, the introduction of N₂ gas from the gas introducing mechanisms 14 and the introduction of microwaves from the microwave introducing mechanism 12 are stopped after a lapse of a predetermined period of time, e.g., several minutes. Then, the pressure in the chamber 21 is raised to a pressure higher than that of the outside environment by the pressure control valve 34. Thereafter, the loading/unloading port 21 is opened by the gate valve 22, and the dummy wafer Wd is unloaded through the loading/unloading port 21 (unloading step) (step S24).

Next, it is determined whether or not a series of procedures including the loading of the dummy wafer Wd, the introduction of N₂ gas, the introduction of microwaves, and the unloading of the dummy wafer Wd have been performed a predetermined number of times (step S25). When it is determined in the step S25 that a series of procedures have not been performed a predetermined number of times, the process returns to step S21. Otherwise, the process is completed.

With the chamber cleaning process of FIG. 2, N₂ gas is introduced into the chamber 11 accommodating therein a dummy wafer Wd and microwaves are introduced into the chamber 11. Accordingly, the dummy wafer Wd is dielectrically heated by the microwaves to thereby emit radiant heat, and the sidewalls 18 and the like are inductively heated. Then, particles or the like attached to the surfaces of the sidewalls 18 and the like are peeled off by thermal stress and discharged to the outside of the chamber by the flow of N₂ gas introduced into the chamber 11.

As a result, the contamination in the chamber 11 by the particles or the like can be prevented. Particularly, the induction heating has high efficiency and thus, it is not required to bury a heater in the sidewalls 18 and the like. This makes it possible to simplify the configuration of the microwave processing apparatus 10 and reduce the energy consumption of the sidewalls 18 and the like during the heating.

In the chamber cleaning process of FIG. 2, when the loading/unloading port 21 is opened for loading/unloading of the dummy wafer Wd, the particles or the metal atoms can be prevented from entering the chamber 11 from the outside, because the pressure in the chamber 11 has been controlled to have a pressure higher than that of the outside environment.

In the chamber cleaning process of FIG. 2, a series of procedures including the loading of the dummy wafer W, the introduction of N₂ gas, the introduction of microwaves, and the unloading of the dummy wafer Wd are repeated. Therefore, the thermal stress can be repetitively applied to the particles or the like attached to the surfaces of the sidewalls 18 and the like. As a result, the particles or the like can be reliably peeled off.

Further, in the chamber cleaning process of FIG. 2, the microwaves are introduced into the chamber 11 accommodating therein a dummy wafer Wd and absorbed by the dummy wafer Wd. Therefore, the amount of microwaves scattering in the chamber 11 is decreased. Accordingly, occurrences of abnormal discharge caused by the scattered microwaves can be prevented.

When dipoles are included in the particles attached to the sidewalls 18 and the like, the dipoles in the particles are directly subjected to dielectric heating. Therefore, the thermal stress can act on the particles directly and the efficiency of peeling the particles can be improved.

While the embodiment of the present invention has been shown and described, the present invention is not limited to the above embodiment.

For example, in the chamber cleaning process of FIG. 2, the N₂ gas is firstly introduced into the chamber 11 and then, the microwaves are introduced thereinto. However, it is also possible to firstly introduce the microwaves into the chamber 11 and then introduce the N₂ gas into the chamber 11. In that case, particles or the like peeled off by thermal stress are discharged to the outside of the chamber 11 by the flow of the N₂ gas.

Moreover, in the chamber cleaning process of FIG. 2, a power value of the microwaves introduced into the chamber 11 accommodating therein the dummy wafer Wd is not different from a power value of the microwaves introduced into the chamber 11 when the treatment using microwaves is performed on a wafer for manufacturing semiconductor devices. However, the former may be greater than the latter. Hence, the dielectric heating of the dummy wafer Wd by the microwaves and the induction heating of the sidewalls 18 and the like by the microwaves can be facilitated. Accordingly, the peeling off of the particles and the metal atoms by the thermal stress can be facilitated.

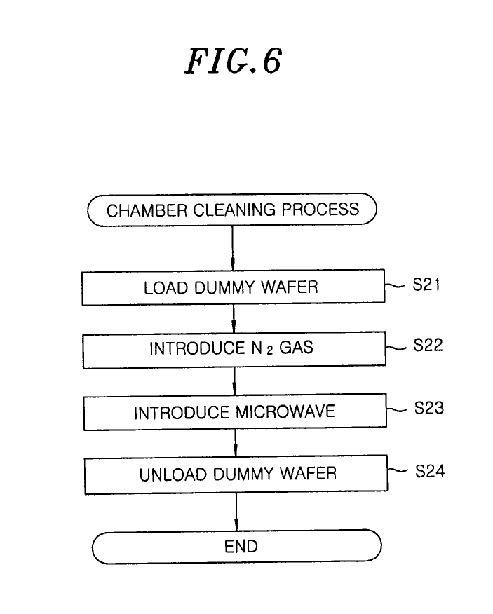

Furthermore, in the chamber cleaning process of FIG. 2, the size of the dummy wafer Wd is not different from that of the wafer W for manufacturing semiconductor devices. However, as shown in FIG. 5, the dummy wafer Wd may be smaller than the wafer W for manufacturing semiconductor devices. In that case, the amount of microwaves absorbed by the dummy wafer Wd is smaller than that of the microwaves absorbed by the wafer W for manufacturing semiconductor devices, and the microwaves are more positively absorbed by the sidewalls 18 and the like. As a result, the induction heating of the sidewalls 18 and the like can be further facilitated.

Further, in the chamber cleaning process of FIG. 2, when the microwaves are introduced into the chamber 11, the dummy wafer Wd may be rotated horizontally by the supporting mechanism 13 or may not be rotated. However, in order to uniformly distribute radiant heat from the dummy wafer Wd to the sidewalls 18 and the like, it is preferable to rotate the dummy wafer WD horizontally.

In the chamber cleaning process of FIG. 2, a series of procedures including the loading of the dummy wafer Wd, the introduction of N₂ gas, the introduction of microwaves, and the unloading of the dummy wafer Wd is repeated. Since, however, the dummy wafer Wd does neither wear down nor raise dust during the irradiation of microwaves to the dummy wafer Wd, the microwaves may be introduced into the chamber 11 for a long period of time in a state where the dummy wafer Wd is accommodated in the chamber 11 without repeating the series of procedures, as shown in FIG. 6.

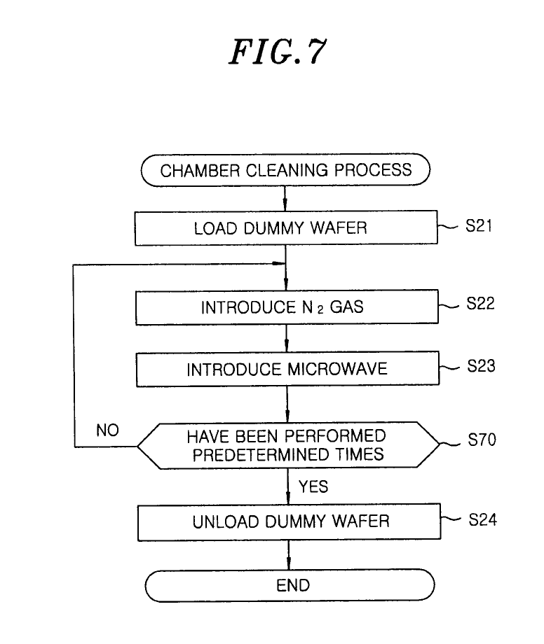

Alternatively, as shown in FIG. 7, only the introduction of N₂ gas into the chamber 11 and the introduction of microwaves into the chamber 11 may be repeated a predetermined number of times in a state where the dummy wafer Wd is accommodated in the chamber 11, and it may be determined whether the introduction of N₂ gas into the chamber 11 and the introduction of microwaves have been repeated the predetermined number of times (step S70). Then, when the introduction of N₂ gas into the chamber 11 and the introduction of microwaves have been repeated the predetermined number of times, the dummy wafer Wd may be unloaded from the chamber 11. In this case, the heat from the dummy wafer Wd accommodated in the chamber 11 can be radiated to the sidewalls 18 and the like for a long period of time, so that the particles or the metal atoms can be reliably peeled off by thermal stress.

### TEST EXAMPLES

Hereinafter, test examples of the present invention will be described in detail.

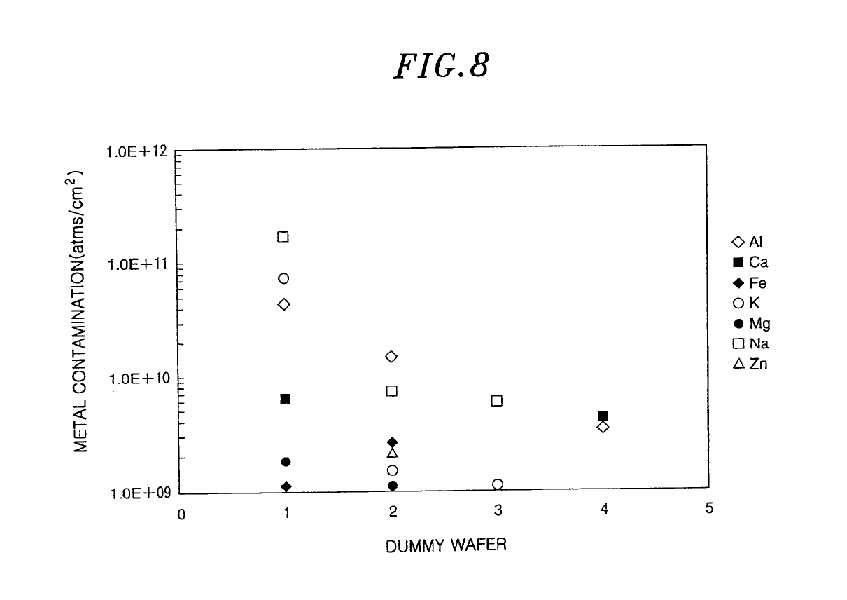

First, in the microwave processing apparatus 10, the chamber cleaning process of FIG. 2 was performed after closing the chamber 11 which has been exposed to the atmosphere for maintenance. Microwaves of about 2000 W were introduced into the chamber 11 and irradiated to a single dummy wafer Wd for about 5 minutes (test example 1). Further, the temperature of the dummy wafer Wd, onto which the microwaves were irradiated, was increased to about 620° C. At this time, the density of metal atoms discharged from the chamber 11 (metal contamination degree) was measured and shown in the graph, which is shown in FIG. 8.

As can be seen from FIG. 8, when the microwaves were introduced into the chamber 11 accommodating therein the first dummy wafer Wd, the density of Na, K, and Al was about 1.0 E+10 (atoms/cm³) or more. However, when the microwaves were introduced into the chamber 11 accommodating therein the third dummy wafer Wd, the density of each kind of the metal atoms was decreased to about 1.0 E+10 (atoms/cm³) or less. In other words, the metal atoms can be removed from the chamber 11 by the chamber cleaning process of FIG. 2, and the contamination of the chamber 11 due to the metal atoms can be prevented.

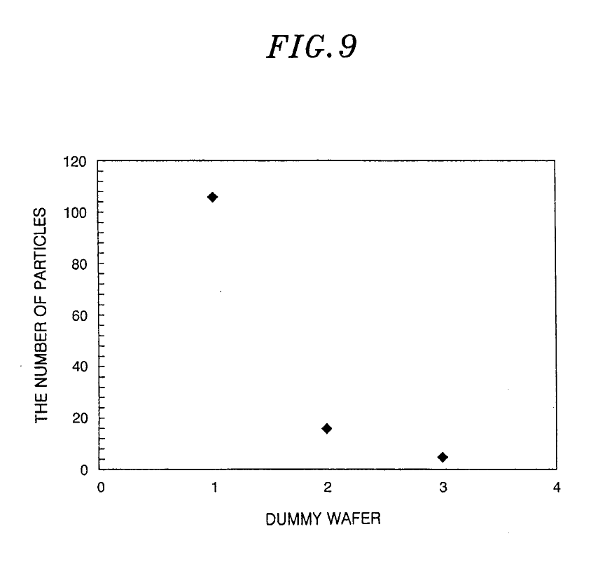

Next, as in the test example 1, the chamber cleaning process of FIG. 2 was performed after closing the chamber 22 which has been exposed to the atmosphere for maintenance in the microwave processing apparatus 10. In a test example 2, microwaves of about 2400 W were introduced into the chamber 11 and irradiated onto a single dummy wafer Wd for about 5 minutes. Further, the temperature of the dummy wafer Wd, to which the microwaves were irradiated, was increased to about 660° C. At this time, the number of particles having a size equal to or greater than about 0.16 μm, which were discharged from the chamber 11, was measured and shown in the graph, which is shown in FIG. 9.

As can be seen from FIG. 9, when the microwaves were introduced into the chamber 11 accommodating therein the first dummy wafer Wd, the number of measured particles was about 100 or more. When the microwaves were introduced into the chamber 11 accommodating therein the second dummy wafer Wd, the number of measured particles was about 20 or less. When the microwaves were introduced into the chamber 11 accommodating therein the fourth dummy wafer Wd, particles were not measured. In other words, by performing the chamber cleaning process of FIG. 2, the particles can be removed from the chamber 11 and the contamination of the chamber 11 due to the particles can be prevented.

While the invention has been shown and described with respect to the embodiments, it will be understood by those skilled in the art that various changes and modifications may be made without departing from the scope of the invention as defined in the following claims.

What is claimed is:

1. A method for cleaning a microwave processing apparatus including a processing chamber for accommodating therein an object to be processed, a microwave introducing unit for introducing microwaves into the chamber, and a gas introducing unit for introducing a gas into the processing chamber, the method comprising:
loading an object for cleaning into the processing chamber;
introducing a gas into the processing chamber;
introducing microwaves into the processing chamber; and
unloading the object from the processing chamber.

2. The method of claim 1, wherein a series of procedures including the loading of the object, the introduction of the gas, the introduction of the microwaves and the unloading of the object are repeated.

3. The method of claim 1, wherein a power value of the microwaves introduced into the processing chamber is greater than a power value of microwaves introduced into the processing chamber in the case of performing treatment using microwaves on an object to be processed for manufacturing semiconductor devices.

4. The method of claim 2, wherein a power value of the microwaves introduced into the processing chamber is greater than a power value of microwaves introduced into the processing chamber in the case of performing treatment using microwaves on an object to be processed for manufacturing semiconductor devices.

5. The method of claim 1, wherein the amount of the microwaves absorbed by the object for cleaning is smaller than the amount of microwaves absorbed by an object to be processed for manufacturing semiconductor devices.

6. The method of claim 2, wherein the amount of the microwaves absorbed by the object for cleaning is smaller than the amount of microwaves absorbed by an object to be processed for manufacturing semiconductor devices.

7. The method of claim 3, wherein the amount of the microwaves absorbed by the object for cleaning is smaller than the amount of microwaves absorbed by the object for manufacturing semiconductor devices.

8. The method of claim 4, wherein the amount of the microwaves absorbed by the object for cleaning is smaller than the amount of microwaves absorbed by the object for manufacturing semiconductor devices.

9. The method of claim 1, wherein a series of procedures including the introduction of the gas and the introduction of the microwaves are repeated.
